(19) United States
(12) Patent Application Publication
(10) Pub. No.: US 2014/0347005 A1
(43) Pub. Date: Nov. 27, 2014

(54) POWER ADAPTER,CONTROLLING METHOD THEREOF AND NOTEBOOK COMPUTER

(71) Applicant: DELTA ELECTRONICS, INC., Taoyuan Hsien (TW)

(72) Inventors: Jian ZHOU, Taoyuan Hsien (TW); Zhuang ZUO, Taoyuan Hsien (TW); Dezhi JIAO, Taoyuan Hsien (TW)

(73) Assignee: DELTA ELECTRONICS, INC., Taoyuan Hsien (TW)

(21) Appl. No.: 14/286,533

(22) Filed: May 23, 2014

(30) Foreign Application Priority Data
May 24, 2013 (CN) 201310198902.6

(51) Int. Cl. H02J 7/00

(52) U.S. Cl. CPC H02J 7/007; H02J 7/0042
USPC 320/107; 320/137

(57) ABSTRACT

The present invention discloses a power adapter, a controlling method thereof and a notebook computer including the power adapter. The power adapter includes a first DC-DC converter and a device charging circuit. The first DC-DC converter has an input terminal and an output terminal. The output terminal of the first DC-DC converter is connected to a first external port. The device charging circuit includes an energy storage unit and at least one second DC-DC converter. An output terminal of each of the at least one second DC-DC converter is connected to at least one second external port. The energy storage unit is connected to the output terminal of the first DC-DC converter so as to receive power therefrom or output power to the first external port, and the at least one second DC-DC converter is connected to the energy storage unit so as to receive power therefrom.

### CROSS-REFERENCE TO RELATED APPLICATIONS

This application claims priority under 35 U.S.C. §119 to Chinese Patent Application No. 201310198902.6, filed on May 24, 2013, the entire contents of which are incorporated herein by reference.

### TECHNICAL FIELD

The present application relates to an adapter, and particularly to a power adapter for notebook computer.

### BACKGROUND

Recently, more and more mobile electronic products which contain battery are used, such as notebook computers, mobile phones, etc. Each electronic device has its own dedicated charger for charging, thus, users have to use proper chargers for the devices. The number of chargers carried by people can be reduced if just one charger can be used for a variety of electronic products.

The existing power adapter of notebook computer is only used for the charging of notebook computer, and when an AC power is not connected, the adapter does not output any energy. Thus, the requirements for the charging of mobile electronic devices cannot be satisfied in the case that the AC power is not supplied. Furthermore, the notebook adapter is not able to charge any other electronic products except notebook. In some cases, a phone call may be needed when the mobile phone is out of power, and people's convenience is influenced as the charging is limited by environmental factors.

In order to enable mobile electronic devices to be charged without being limited by conditions such as time, location, etc., and reduce the number of chargers carried by people, a need exists for a power adapter which has more functions.

### SUMMARY OF THE INVENTION

In view of the above, it is an object of the present application to provide a power adapter, which has an energy storage unit and multiple outputs to charge notebook computer and other mobile devices, so as to solve the problem that the charging of the mobile electronic devices is limited by conditions such as environmental factors.

In one aspect, the present application provides a power adapter, which includes a first DC-DC converter and a device charging circuit. The first DC-DC converter has an input terminal and an output terminal, and the output terminal of the first DC-DC converter is connected to a first external port. The device charging circuit includes an energy storage unit and at least one second DC-DC converter. The output terminal of each of the at least one second DC-DC converter is connected to at least one second external port. The energy storage unit is connected to the output terminal of the first DC-DC converter and the at least one second DC-DC converter so as to achieve at least one of the following: receiving power outputted from the first DC-DC converter, outputting power to the first external port, outputting power to the at least one second external port through the at least one second DC-DC converter.

According to some embodiments, the power adapter further includes a rectifier circuit, the rectifier circuit has an input terminal and an output terminal, the input terminal of the rectifier circuit is connected to an AC power while the output terminal of the rectifier circuit is connected to the input terminal of the first DC-DC converter.

According to some embodiments, the first external port outputs a first voltage, the first voltage is supplied to the notebook computer for charging, and the first voltage comes from the AC power or the energy storage unit.

According to some embodiments, the second external port outputs a second voltage, the second voltage is supplied to the mobile electronic devices for charging, and the second voltage comes from the AC power or the energy storage unit.

According to some embodiments, the mobile electronic devices comprise, for example, a mobile phone, a digital camera, MP3, MP4, MPS, PMP (Portable Media Player), DSC (Digital Still Camera), DVR (Digital Video Recorder), or a game machine, etc.

According to some embodiments, the energy storage unit is connected to both the output terminal and the input terminal of the first DC-DC converter, the energy storage unit outputs energy to the input terminal of the first DC-DC converter and outputs energy to the first external port through the first DC-DC converter, or receives energy outputted from the first DC-DC converter.

According to some embodiments, the device charging circuit further includes a third DC-DC converter, the third DC-DC converter is connected between the output terminal of the first DC-DC converter and the first external port.

According to some embodiments, the notebook computer is connected to the first external port, and the power of the notebook computer provides energy to charge the energy storage unit through the third DC-DC converter.

According to some embodiments, the notebook computer is connected to the first external port, and the third DC-DC converter provides energy which comes from the AC power or the energy storage unit to the power of the notebook computer for charging.

According to some embodiments, the third DC-DC converter includes a buck converter.

According to some embodiments, the second DC-DC converter includes a buck converter.

According to some embodiments, the first DC-DC converter includes a flyback converter, a LLC converter, a full bridge converter, or a buck-boost converter.

According to some embodiments, the device charging circuit includes a protection circuit which includes an over power protection circuit and a short-circuit protection circuit.

According to some embodiments, the power adapter further includes a control circuit, which is connected with the rectifier circuit, the first DC-DC converter and the at least one second DC-DC converter for controlling the operations thereof.

According to some embodiments, the control circuit further includes:

an input detecting circuit which is connected with the input terminal of the rectifier circuit for detecting whether the AC power is available or not;

a first load detecting circuit which is connected with the first external port for detecting whether the notebook computer is connected to the first external port or not;

at least one second load detecting circuit which is connected with the at least one second external port for detecting whether at least one mobile electronic device is connected to the at least one second external port or not.

According to some embodiments, the at least one second external port is a USB port.

According to any one of the above power adapters, the energy storage unit is a rechargeable element, such as a rechargeable battery, a rechargeable capacitor or the like.

Besides, the energy storage unit may include a power management circuit and a charging/discharging circuit, etc.

According to some embodiments, the rectifier circuit may be a PFC (Power Factor Correction) circuit, but not limited thereto.

In another aspect, the present application also provides a controlling method of power adapter which is any one of the above power adapters, the method includes the following steps:

detecting whether AC power is available or not through the input terminal of the rectifier circuit;

detecting whether a notebook computer is connected to the first external port or not through the first external port;

detecting whether at least one mobile electronic device is connected to at least one second external port or not through the least one second external port; and

when the AC power is available, controlling the power adapter to operate in a first operating mode; when the AC power is unavailable, controlling the power adapter to operate in a second operating mode.

According to some embodiments, the first operating mode is that: the AC power provides energy to charge the energy storage unit through the rectifier circuit and the first DC-DC converter; when the notebook computer is connected to the first external port, the first external port outputs voltage to charge the notebook computer, and the output voltage comes from the AC power; when at least one second load is connected to the at least one second external port, the at least one second external port outputs voltage to charge the at least one second load, and the output voltage comes from the AC power.

According to some embodiments, the second operating mode is that: when the notebook computer is connected to the first external port, the first external port outputs voltage to charge the notebook computer, and the output voltage comes from the energy storage unit; or the energy of the notebook computer power charges the energy storage unit through the first external port; when at least one second load is connected to the at least one second external port, the at least one second external port outputs voltage to charge the at least one second load, and the output voltage comes from the energy storage unit or the power of the notebook computer.

In still another aspect, the present application also provides a notebook computer which includes any one of the above power adapters.

As compared with the prior art, the power adapter according to the present application can provide flexible and safe charging, make the mobile electronic devices be charged without being limited by conditions such as time, location, etc., and a variety of mobile electronic devices can be charged by the same power adapter, which can bring convenience.

### BRIEF DESCRIPTION OF THE DRAWINGS

FIG. 1 is a schematic view showing the structure of the power adapter according to the first embodiment.

FIG. 2 is a schematic view showing the structure of another power adapter according to the first embodiment.

FIG. 3 is a flow chart showing the controlling method of the power adapter according to the first embodiment.

FIG. 4 shows a circuit diagram of the power adapter according to the first embodiment.

FIG. 5 shows an essential circuit diagram of the device charging circuit according to the first embodiment.

FIG. 6 is a schematic view showing the structure of the power adapter according to the second embodiment.

FIG. 7 is a flow chart showing the controlling method of the power adapter according to the second embodiment.

FIG. 8 is a schematic view showing the structure of the power adapter according to the third embodiment.

FIG. 9 is a flow chart showing the controlling method of the power adapter according to the third embodiment.

### DETAILED DESCRIPTION

The present application will be described in more detail with reference to the drawings and embodiments. It should be understood that the embodiments are provided for illustrating rather than limiting the present application. Besides, for the sake of easier description, what is shown in the drawings is just the part related to the present application, but not the entire structure.

The First Embodiment

The embodiment provides a power adapter and controlling method thereof. The essential structure of the power adapter is shown in FIG. 1. The power adapter includes a rectifier circuit, a first DC-DC converter, and a device charging circuit.

In an example, the rectifier circuit may be a PFC (Power Factor Correction) circuit, but the rectifier circuit is not limited to this. The skilled person in the art can choose any circuit which can transform AC supply to DC voltage. However, for the convenience of description, the embodiments herein are described by taking the PFC circuit as an example.

Each of the PFC circuit and the first DC-DC converter has an input terminal and an output terminal. The input terminal of the PFC circuit is connected to an AC power.

The first DC-DC converter includes any one or several of a flyback converter, a LLC converter, a full bridge converter, or a buck-boost converter. The first DC-DC converter may also include other types of DC-DC converter.

The device charging circuit includes an energy storage unit and at least one second DC-DC converter. The energy storage unit is a rechargeable element, such as a battery, a capacitor or the like. Besides, the energy storage unit may include a power management circuit and a charging/discharging circuit, etc. Taking a rechargeable battery as an example, a rechargeable battery is generally a lithium battery, a nickel-hydrogen battery or the like, the voltage across a standard lithium battery is 4.2v, and generally the voltage across three or four batteries connected in series is 12.6V or 16.8V. However, in order to meet the general requirements on the input voltage of the notebook computer, it is possible to preorder a rechargeable battery, the voltage across which is 19V. The second DC-DC converter includes a voltage-reducing converter, such as a buck converter.

In the power adapter, the connection relations among the PFC circuit, the first DC-DC converter and the device charging circuit are as follows: the output terminal of the PFC circuit is connected to the input terminal of the first DC-DC converter, the output terminal of the first DC-DC converter is connected to the first external port Vout 1, and the energy storage unit of the device charging circuit is connected to the output terminal of the first DC-DC converter. The AC current flows through the PFC circuit and the first DC-DC converter, and then can directly charge the energy storage unit. The energy stored in the energy storage unit can be directly transmitted to the first external port Vout 1 when the AC power is unavailable.

The first external port Vout 1 outputs the voltage with the level of 19V, 12V or the like, which is the main output, for charging the external notebook computer.

The energy storage unit is connected to at least one second DC-DC converter.

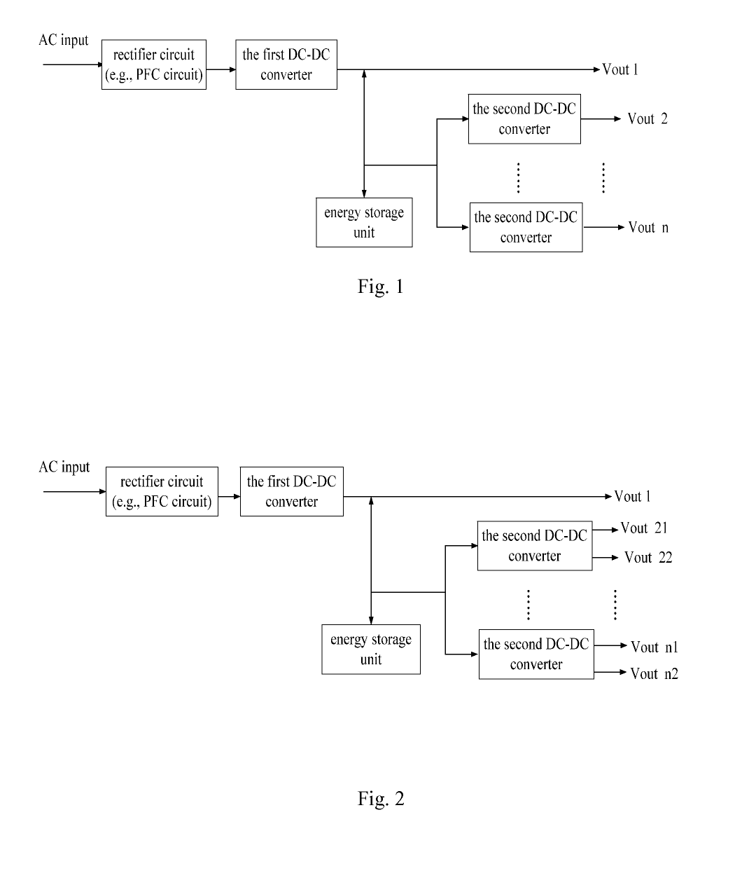

As shown in FIG. 1 and FIG. 2, the energy storage unit can be connected to 1st to nth second DC-DC converters. Each of the output terminals of the second DC-DC converters is connected to at least one second external port respectively. The energy storage unit outputs energy to the second external ports through the at least one second DC-DC converter.

FIG. 1 shows that each of the output terminals of the second DC-DC converters is connected to one second external port, 1st to (n−1)th second DC-DC converters are connected to 1st to (n−1)th second external ports Vout 2 to Vout n respectively. FIG. 2 shows that each of the output terminals of the second DC-DC converters is connected to two second external ports. FIG. 1 and FIG. 2 are just for illustrative purpose. In practice, the number of the second external ports connected to each of the output terminals of the second DC-DC converters may be plural, and may be the same as or different from each other, which can be selected by the skilled person in the art according to the actual requirement. The same case will be applied in the second and third embodiments.

The second external ports Vout 2 to Vout n are the USB auxiliary outputs for charging the external mobile electronic devices, such as a mobile phone, a digital camera, MP3, MP4, MP5, PMP, DSC, DVR, or a game machine, etc., the output voltage is 5V or 3.3V, etc. The types of mobile electronic devices are not limited to the above described types and may increase with the development of technology. When the AC power is available, the AC current flows through the PFC circuit and the first DC-DC converter, and then flows through the second DC-DC converter, so as to output voltage through the second external ports to charge the mobile electronic devices. When the AC power is unavailable, the energy stored in the energy storage unit, after flowing through the second DC-DC converter, is outputted to charge the mobile electronic devices through the second external ports.

The first external port and the plurality of the second external ports can provide multi-channel DC outputs for charging the notebook computer and mobile electronic devices at the same time, thus reducing the number of chargers needed to be carried.

The power adapter according to the embodiment further includes a control circuit, and the control circuit is connected to the PFC circuit, the first DC-DC converter and the at least one second DC-DC converter for controlling the operations thereof. The control circuit includes: an input detecting circuit which is connected with the input terminal of the PFC circuit for detecting whether the AC power is available or not; a first load detecting circuit which is connected with the first external port of the power adapter for detecting whether the notebook computer is connected to the first external port or not; and at least one second load detecting circuit which is connected with the at least one second external port of the power adapter for detecting whether at least one mobile electronic device is connected to the at least one second external port or not.

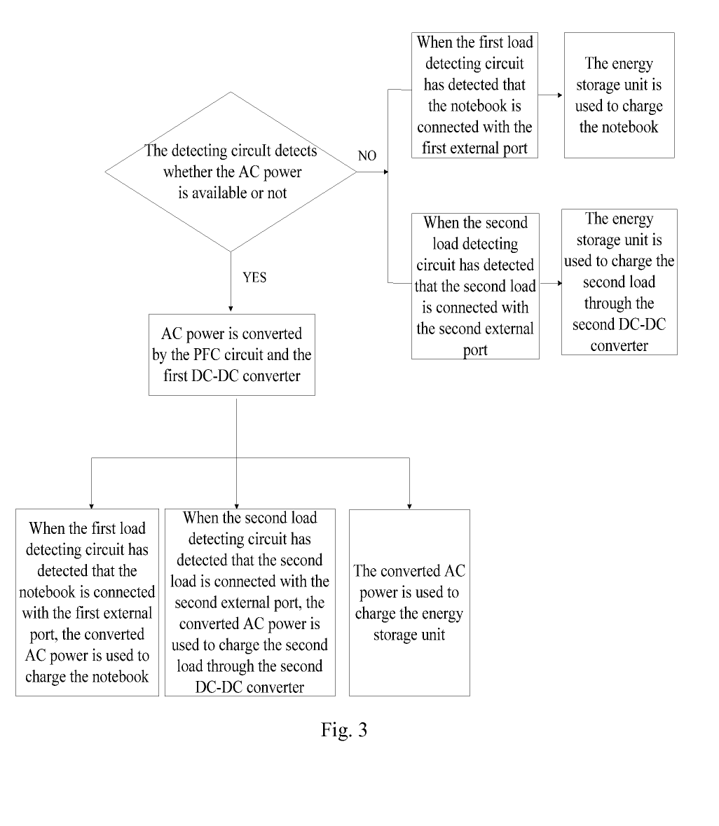

The method of controlling the operations of the PFC circuit, the first DC-DC converter and the at least one second DC-DC converter by the control circuit in the power adapter according to the embodiment is described below. FIG. 3 shows the main steps of the controlling method.

The detecting circuit detects whether the AC power is available or not through the input terminal of the PFC circuit. When the detecting circuit detects that the AC power is available, the power adapter operates in a first operating mode, in which the PFC circuit and the first DC-DC converter are used to convert the AC power, and the converted AC power charges the energy storage unit which is connected to the output terminal of the first DC-DC converter.

When the first load detecting circuit has detected that the notebook computer is connected to the first external port Vout 1, the converted AC power outputs voltage to charge the notebook computer through the first external port.

When the at least one second load detecting circuit has detected that at least one second load is connected to the at least one second external port, the converted AC power is further converted by the second DC-DC converter, and then outputs voltage through the second external ports to charge the second loads, that is, the mobile electronic devices such as a mobile phone, a digital camera, MP3, MP4, MP5, PMP, DSC, DVR, or a game machine, etc. The second external ports can be Vout 2 to Vout n.

When the detecting circuit has detected that the AC power is cut off, the power adapter operates in a second operating mode, in which the energy stored in the energy storage unit is utilized.

When the first load detecting circuit has detected that the notebook computer is connected to the first external port Vout 1, the energy storage unit outputs voltage to charge the notebook computer through the first external port Vout 1 of the power adapter.

When the at least one second load detecting circuit has detected that at least one second load is connected to the at least one second external port, the energy stored in the energy storage unit is converted by the second DC-DC converter, and then outputs voltage through the second external ports to charge the second loads, that is, the mobile electronic devices. The second external ports can be Vout 2 to Vout n.

The power adapter and controlling method thereof according to the embodiment can be used, when the external power is available, to charge the energy storage unit inside the power adapter, and can provide multi-channel DC outputs at the same time, so that the power adapter have a plurality of interfaces to charge the notebook computer and mobile electronic devices, thus reducing the number of chargers needed to be carried and bringing convenience; when the external power is unavailable, the energy storage unit can be used to provide energy to the notebook computer or the mobile electronic devices, the notebook computer and the mobile electronic devices (such as a mobile phone, a digital camera, MP3, MP4, MP5, PMP, DSC, DVR, or a game machine, etc.) are enabled to be charged without being limited by conditions such as time, location, etc., and the power adapter provides multi-channel DC outputs at the same time, thus reducing the number of chargers needed to be carried.

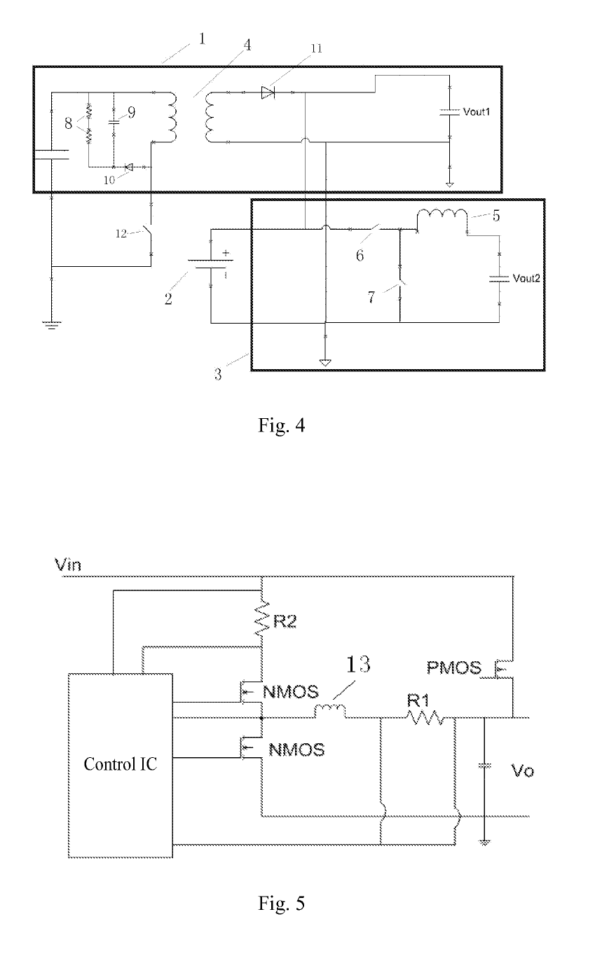

FIG. 4 shows the circuit diagram of the power adapter according to the embodiment. The circuit includes a PFC circuit, and the PFC circuit is not shown in FIG. 4 as it is a common circuit. A first DC-DC converter circuit is connected to the PFC circuit, and the first DC-DC converter is a flyback converter in a preferred embodiment. In FIG. 4, Part 1 denotes the flyback converter circuit. The flyback converter circuit includes a transformer 4, one end of the primary winding of the transformer 4 is connected to the anode of the power capacitor, and the other end of the primary winding of the transformer 4 is connected to the cathode of the power capacitor through a switch tube 12. The primary winding of the transformer 4 is also connected in parallel with an RCD circuit. The RCD circuit is composed of a bleeder resistor 8 (R), a capacitor 9 (C) and a diode 10 (D).

One end of the secondary winding of the transformer 4 is connected in series with a diode, and the other end of the secondary winding of the transformer 4 is grounded. The energy storage unit 2 is connected to two ends of the secondary winding of the transformer 4. After one end of the secondary winding of the transformer 4 is connected in series with the diode, it is connected to the first external port.

The energy storage unit 2 is connected to the second external port Vout 2 through a buck converter 3, in addition to be connected in parallel with the secondary winding of the transformer 4. The buck converter 3 includes an inductor 5 and a first switch 6 and a second switch 7, wherein the first switch 6 and the second switch 7 cannot turn on or turn off at the same time. The energy storage unit outputs energy to the second external port through the buck converter 3, and the energy outputted from the flyback converter circuit 1 also can be outputted to the second external port through the buck converter 3.

As an example, FIG. 4 shows that the power adapter has one buck converter and one external port. It should be understood by the skilled person in the art that the energy storage unit can be connected to a plurality of external ports through a plurality of buck converters.

In the case that the AC power is available, after being corrected by the PFC circuit, the AC power is applied to the two ends of the power capacitor. By the switching operations of the switch tube 12, the current is supplied to the primary winding of the transformer to generate an alternating magnetic field, so that the alternating voltage and current are induced by the secondary winding of the transformer. The RCD circuit connected in parallel with the primary winding of the transformer 4 is used to protect the switch tube 12 by absorbing the peak voltage generated by the transformer. The alternating voltage and current are rectified by the diode 11 to be outputted directly to the first external port to charge the notebook computer connected thereto.

Meanwhile, the voltage and current rectified by the diode can also be outputted to the energy storage unit 2 for charging it, or the voltage can be reduced by the buck converter 3 to be supplied to the second external port Vout 2 for charging the external mobile electronic devices connected thereto, such as a mobile phone, a digital camera, MP3, MP4, MP5, PMP, DSC, DVR, or a game machine, etc.

In the case that the AC power is unavailable, when the notebook computer connected to the first external port is needed to be charged, the energy storage unit 2 is used to provide energy to the first external port to charge the notebook computer. Meanwhile, the energy storage unit 2 also can be used to provide energy to the second external ports Vout 2 through the buck converters 3 to charge the external mobile electronic devices connected thereto, such as a mobile phone, a digital camera, MP3, MP4, MP5, PMP, DSC, DVR, or a game machine, etc.

The energy storage unit is a battery as shown in FIG. 4. In the case that the energy storage unit is a battery, a protection circuit is added to the energy storage unit so that the energy storage unit can be charged or discharged safely. The protection circuit includes an over power protection circuit and a short-circuit protection circuit, and the over power protection circuit further includes an over current protection (OCP) circuit and an over voltage protection (OVP) circuit. As the battery is charged or discharged, the terminal voltage of the battery may vary in a fixed range of voltage. A rechargeable battery may have a control IC used to control the charging of the battery, so that the battery is charged safely in constant current/constant voltage mode according to the characteristic of the battery. Meanwhile, a protection circuit may be added to the control circuit so as to protect the battery from over current, over voltage or short-circuit in the process of charging.

FIG. 5 exemplarily shows the essential circuit diagram of the battery when the energy storage unit in the device charging circuit is battery. The circuit of the battery includes: a control IC used to protect the battery in the process of charging; a sampling resistor R2 connected with the control IC; a power converter connected with the control IC and composed of two NMOS transistors and an inductor 13; and a sampling resistor R1 connected between the power converter and an external port Vo. The external port Vo is used to be connected to a rechargeable battery, that is, the energy storage unit.

When the Vin is unavailable, the PMOS transistor turns on, and the rechargeable battery connected to the external port Vo outputs energy through the PMOS transistor; When the Vin is available and the capacity of the battery is less than 95%, the battery starts to be charged, and the PMOS transistor turns off. The current is supplied through the sampling resistor R2 connected with the control IC, the power converter composed of two NMOS transistors and one inductor 13, and the sampling resistor R1, so as to charge the rechargeable battery. At this time, it is possible to achieve over current protection (OCP) and short-circuit protection (SCP) by detecting the output current and voltage across the sampling resistor R1 and to achieve the over-voltage protection (OVP) by directly detecting the output voltage, so as to charge the rechargeable battery safely.

The circuit disclosed in the embodiment, where the energy storage unit is a battery, can protect the battery to be charged or discharged safely.

The Second Embodiment

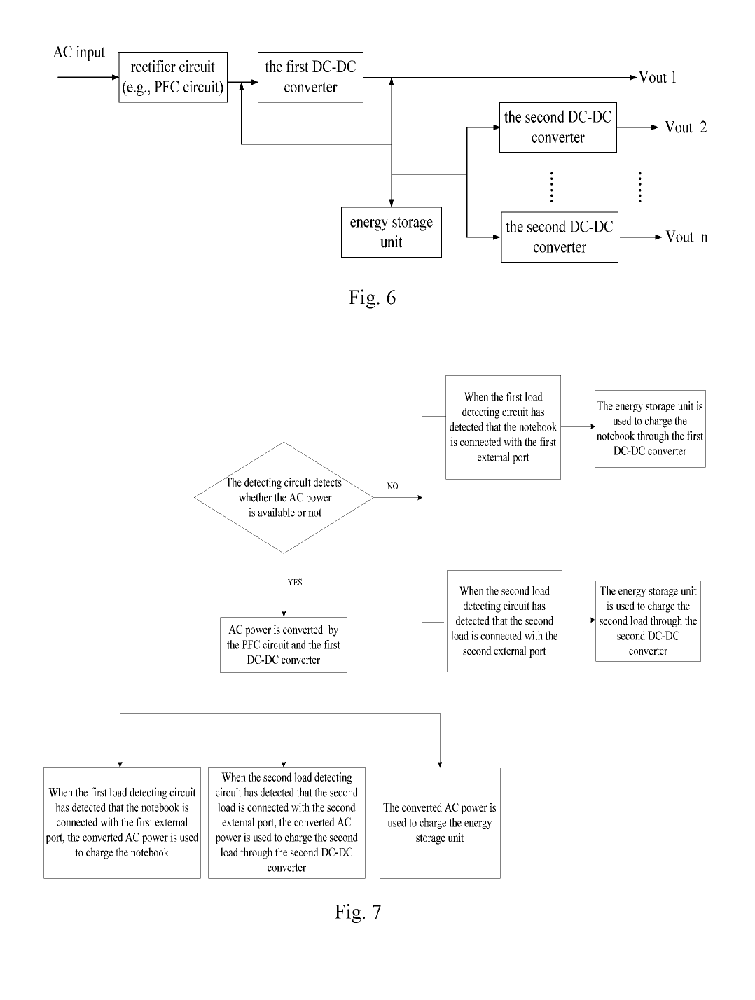

The embodiment provides another power adapter and controlling method thereof. The essential structure of the power adapter is shown in FIG. 6. The power adapter includes a PFC circuit, a first DC-DC converter, and a device charging circuit.

Each of the PFC circuit and the first DC-DC converter has an input terminal and an output terminal. The input terminal of the PFC circuit is connected to an AC power.

The first DC-DC converter includes any one or several of a flyback converter, a LLC converter, a full bridge converter, or a buck-boost converter. The first DC-DC converter may also include other types of DC-DC converter.

The device charging circuit includes an energy storage unit and at least one second DC-DC converter. The energy storage unit is a rechargeable element, such as a battery, a capacitor or the like. Taking a rechargeable battery as an example, a rechargeable battery is generally a lithium battery, a nickel-hydrogen battery or the like, the voltage across a standard lithium battery is 4.2v, and generally the voltage across three or four batteries connected in series is 12.6V or 16.8V. However, in order to meet the general requirements on the input voltage of the notebook computer, it is possible to preorder a rechargeable battery, the voltage across which is 19V. The second DC-DC converter includes a voltage-reducing converter, such as a buck converter.

The connection relations among the PFC circuit and the first DC-DC converter and the device charging circuit in the power adapter of this embodiment are different from those in the first embodiment. The connection relations in this embodiment are as follows: the output terminal of the PFC circuit is connected to the input terminal of the first DC-DC converter, and the output terminal of the first DC-DC converter is connected to the first external port Vout 1, the energy storage unit of the device charging circuit is connected to both the input terminal and the output terminal of the first DC-DC converter (as shown in FIG. 6), but no longer as in the first embodiment that the energy storage unit of the device charging circuit is only connected to the output terminal of the first DC-DC converter. When the AC power is available, the AC current flows through the PFC circuit and the first DC-DC converter and then may charge directly the energy storage unit. When the AC power is unavailable, the energy stored in the energy storage unit can be converted by the first DC-DC converter and then be outputted to the first external port Vout 1. The purpose is to provide a stable voltage for the notebook computer with excluding some cases that the voltage is unstable by means of converting the energy of the energy storage unit by the first DC-DC converter.

The first external port Vout 1 outputs the voltage with the level of 19V, 12V or the like, which is the main output, for charging the external notebook computer.

The energy storage unit is connected to at least one second DC-DC converter. As shown in FIG. 6, the energy storage unit can be connected to 1st to (n−1)th second DC-DC converters, and the second external ports Vout 2 to Vout n are connected to the output terminals of the 1st to (n−1)th second DC-DC converters respectively. The second external ports Vout 2 to Vout n are the USB auxiliary outputs for charging the external mobile electronic devices, such as a mobile phone, a digital camera, MP3, MP4, MP5, PMP, DSC, DVR, or a game machine, etc., the output voltage is 5V or 3.3V, etc. When the AC power is available, the AC current flows through the PFC circuit and the first DC-DC converter, and then flows through the second DC-DC converters, so as to output voltage through the second external ports to charge the mobile electronic devices. When the AC power is unavailable, the energy stored in the energy storage unit, after flowing through the second DC-DC converters, is outputted to charge the mobile electronic devices through the second external ports.

In practical implementation, in case that the first DC-DC converter is of separation type, the energy storage unit cannot supply energy to the input of the first DC-DC converter directly, thus, an additional DC-DC converter (not shown) needs to be added between the PFC circuit and the energy storage unit for transmitting energy.

The first external port and the plurality of the second external ports can provide multi-channel DC outputs for charging the notebook computer and mobile electronic devices at the same time, thus reducing the number of chargers needed to be carried.

The power adapter according to the embodiment further includes: an input detecting circuit which is connected with the input terminal of the PFC circuit for detecting whether the AC power is available or not; a first load detecting circuit which is connected with the first external port of the power adapter for detecting whether the notebook computer is connected to the first external port or not; and at least one second load detecting circuit which is connected with the at least one second external port of the power adapter for detecting whether at least one mobile electronic device is connected to the at least one second external port or not.

The controlling method of the power adapter according to the embodiment is described below. FIG. 7 shows the main steps of the controlling method.

The detecting circuit detects whether the AC power is available or not through the input terminal of the PFC circuit. When the detecting circuit detects that the AC power is available, the power adapter operates in a first operating mode, in which the PFC circuit and the first DC-DC converter are used to convert the AC power, and the converted AC power charges the energy storage unit which is connected to the output terminal of the first DC-DC converter.

When the first load detecting circuit has detected that the notebook computer is connected to the first external port Vout 1, the converted AC power outputs voltage to charge the notebook computer through the first external port.

When the at least one second load detecting circuit has detected that at least one second load is connected to the at least one second external port, the converted AC power is further converted by the second DC-DC converter, and then outputs voltage through the second external ports to charge the second loads, that is, the mobile electronic devices such as a mobile phone, a digital camera, MP3, MP4, MP5, PMP, DSC, DVR, or a game machine, etc. The second external ports can be Vout 2 to Vout n.

When the detecting circuit has detected that the AC power is cut off, the power adapter operates in a second operating mode, in which the energy stored in the energy storage unit is utilized.

When the first load detecting circuit has detected that the notebook computer is connected to the first external port Vout 1, the energy of the energy storage unit is converted by the first DC-DC converter and then is outputted to charge the notebook computer through the first external port Vout 1 of the power adapter. The difference between this embodiment and the first embodiment is that before the energy of the energy storage unit is outputted to charge the notebook computer through the first external port Vout 1 of the power adapter, it has been converted by the first DC-DC converter. The advantage is that the conversion of the first DC-DC converter can be used to provide a stable voltage for the notebook computer when the voltage supplied from the energy storage unit is fluctuating.

When the at least one second load detecting circuit has detected that at least one second load is connected to at least one second external port, the energy of the energy storage unit is converted by the second DC-DC converters, and the converted energy is used to output voltage through the second external ports to charge the second loads, that is, the mobile electronic device. The second external ports can be Vout 2 to Vout n.

The power adapter and controlling method thereof provided by the embodiment can be used, when the external power is available, to charge the energy storage unit inside the power adapter, and to provide multi-channel DC outputs at the same time, so that the power adapter have a plurality of interfaces to charge the notebook computer and mobile electronic devices, thus reducing the number of chargers needed to be carried and bringing convenience; when the external power is unavailable, the energy storage unit can be used to provide energy to the notebook computer or the mobile electronic devices, such that the notebook computer and the mobile electronic devices (such as a mobile phone, a digital camera, MP3, MP4, MP5, PMP, DSC, DVR, or a game machine, etc.) are enabled to be charged without being limited by conditions such as time, location, etc., and the power adapter provides multi-channel DC outputs at the same time, thus reducing the number of chargers needed to be carried.

The Third Embodiment

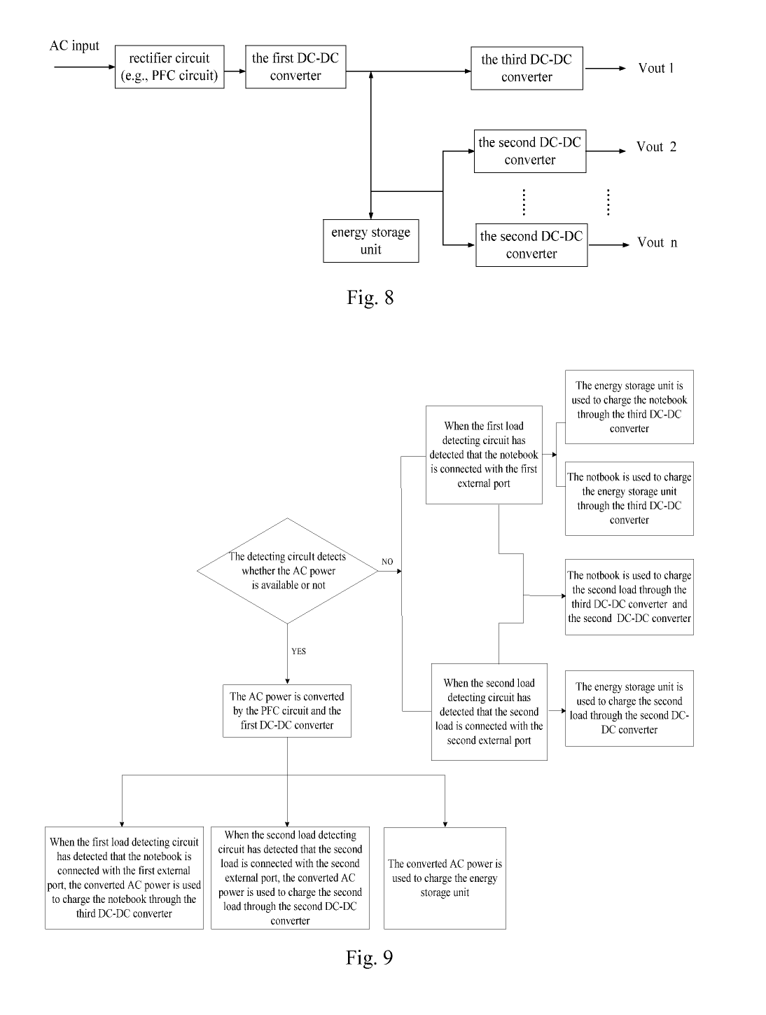

The embodiment provides a power adapter and controlling method thereof. The essential structure of the power adapter is shown in FIG. 8. The power adapter includes a PFC circuit, a first DC-DC converter, a device charging circuit, and a third DC-DC converter. Each of the PFC circuit and the first DC-DC converter has an input terminal and an output terminal, and the input terminal of the PFC circuit is connected to an AC power.

The first DC-DC converter includes any one or several of a flyback converter, a LLC converter, a full bridge converter, or a buck-boost converter. The first DC-DC converter may also include other types of DC-DC converter.

The device charging circuit includes an energy storage unit and at least one second DC-DC converter. The energy storage unit is a rechargeable element, such as a battery, a capacitor or the like. Taking a rechargeable battery as an example, a rechargeable battery is generally a lithium battery, a nickel-hydrogen battery or the like, the voltage across a standard lithium battery is 4.2v, and generally the voltage across three or four batteries connected in series is 12.6V or 16.8V. However, in order to meet the general requirements on the input voltage of the notebook computer, it is possible to preorder a rechargeable battery, the voltage across which is 19V. The second DC-DC converter includes a voltage-reducing converter, such as a buck converter.

In the power adapter, the connection relations among the PFC circuit, the first DC-DC converter, the device charging circuit and the third DC-DC converter are as follows: the output terminal of the PFC circuit is connected to the input terminal of the first DC-DC converter, the output terminal of the first DC-DC converter is connected to the input terminal of the third DC-DC converter, the output terminal of the third DC-DC converter is connected to the first external port Vout 1, the energy storage unit of the device charging circuit is connected to the output terminal of the first DC-DC converter, and the energy storage unit of the device charging circuit is connected to the input terminal of the third DC-DC converter.

When the AC power is available, the AC current flows through the PFC circuit and the first DC-DC converter and then may directly charge the energy storage unit. When the AC power is unavailable, the energy of the energy storage unit can be transmitted to the first external port Vout 1 through the third DC-DC converter.

The first external port Vout 1 outputs the voltage with the level of 19V, 12V, etc, which is the main output, for charging the external notebook computer.

The energy storage unit is connected to at least one second DC-DC converter. As shown in FIG. 8, the energy storage unit can be connected to 1st to (n−1)th second DC-DC converters, and the second external ports Vout 2 to Vout n are connected to the 1st to (n−1)th second DC-DC converters respectively. The second external ports Vout 2 to Vout n are the USB auxiliary outputs for charging the external mobile electronic devices, such as a mobile phone, a digital camera, MP3, MP4, MP5, PMP, DSC, DVR, or a game machine, etc., the output voltage is 5V or 3.3V, etc. When the AC power is available, the AC current flows through the PFC circuit and the first DC-DC converter, and then flows through the second DC-DC converters, so as to output voltage to charge the mobile electronic devices through the second external ports. When the AC power is unavailable, the energy of energy storage unit is outputted through the second DC-DC converters to charge the mobile electronic devices through the second external ports. And in this case, if the notebook computer is connected to the first external port, the power of the notebook computer can be used to charge the mobile electronic devices through the third DC-DC converter and the second DC-DC converters and the second external ports.

The first external port and the plurality of the second external ports can provide multi-channel DC outputs for charging the notebook computer and mobile electronic devices at the same time, thus reducing the number of chargers needed to be carried.

As compared with the first embodiment, the third DC-DC converter is added to the power adapter according to the embodiment, and the third DC-DC converter is connected between the first DC-DC converter and the first external port, the energy storage unit is connected to the input terminal of the third DC-DC converter. In the case that a suitable external power is unavailable and there is no energy in the energy storage unit, the notebook computer connected to the first external port can charge the energy storage unit through the third DC-DC converter, and can charge the mobile electronic devices connected to the second external ports, thus bringing convenience. And when a suitable external power is available or there is energy in the energy storage unit, the external power or the energy storage unit can charge the notebook computer connected to the first external port through the third DC-DC converter, but no longer as in the first embodiment that the external power or the energy storage unit directly outputs voltage to the first external port.

The power adapter according to the embodiment further includes: an input detecting circuit which is connected with the input terminal of the PFC circuit for detecting whether the AC power is available or not; a first load detecting circuit which is connected with the first external port of the power adapter for detecting whether the notebook computer is connected to the first external port or not; and at least one second load detecting circuit which is connected with the at least one second external port of the power adapter for detecting whether at least one mobile electronic device is connected to the at least one second external port or not.

The controlling method of the power adapter according to the embodiment is described below. FIG. 9 shows the main steps of the controlling method.

The detecting circuit detects whether the AC power is available or not through the input terminal of the PFC circuit; when the detecting circuit detects that the AC power is available, the power adapter operates in a first operating mode, in which the PFC circuit and the first DC-DC converter convert the AC power, and the converted AC power is used to charge the energy storage unit which is connected to the output terminal of the first DC-DC converter.

When the first load detecting circuit has detected that the notebook computer is connected to the first external port Vout 1, the converted AC power outputs voltage to charge the notebook computer through the third DC-DC converter and the first external port.

When the at least one second load detecting circuit has detected that at least one second load is connected to the at least one second external port, the converted AC power is further converted by the second DC-DC converter, and then outputs voltage through the second external ports to charge the second loads, that is, the mobile electronic devices such as a mobile phone, a digital camera, MP3, MP4, MP5, PMP, DSC, DVR, or a game machine, etc. The second external ports can be Vout 2 to Vout n.

When the detecting circuit has detected that the AC power is cut off, the power adapter operates in a second operating mode, in which the energy of the energy storage unit or the energy of the notebook computer power is utilized.

When the first load detecting circuit has detected that the notebook computer is connected to the first external port Vout 1, the energy storage unit outputs voltage through the third DC-DC converter to the first external port Vout 1 of the power adapter to charge the notebook computer.

When the at least one second load detecting circuit has detected that at least one second load is connected to at least one second external port, the energy of the energy storage unit is converted by the second DC-DC converters, and the converted energy outputs voltage through the second external ports to charge the second loads, that is, the mobile electronic devices. The second external ports can be Vout 2 to Vout n.

When the first load detecting circuit has detected that the notebook computer is connected to the first external port Vout 1, and the at least one second load detecting circuit has detected that at least one second load is connected to the at least one second external port, the power of the notebook computer can output voltage through the third DC-DC converter and the second DC-DC converters to the second external ports, so as to charge the second loads, that is, the mobile electronic devices.

The power adapter and controlling method thereof according to the embodiment can be used, when the external power is available, to charge the energy storage unit inside the power adapter, and to provide multi-channel DC outputs at the same time, so that the power adapter have a plurality of interfaces to charge the notebook computer and mobile electronic devices, thus reducing the number of chargers needed to be carried and bringing convenience; when the external power is unavailable, the energy storage unit can be used to provide energy to the notebook computer or the mobile electronic devices, such that the notebook computer and the mobile electronic devices (such as a mobile phone, a digital camera, MP3, MP4, MP5, PMP, DSC, DVR, or a game machine, etc.) are enabled to be charged without being limited by conditions such as time, location, etc., and the power adapter provides multi-channel DC outputs at the same time, thus reducing the number of chargers needed to be carried; and when the external power is unavailable and there is no energy in the energy storage unit, the power of the notebook computer can be used to charge the mobile electronic devices, which provides a measure against emergent events, thus bringing convenience.

Although the present invention has been described and illustrated in detail, it is clearly understood that the same is by way of illustration and example only and is not to be taken by way of limitation, the spirit and scope of the present invention being limited only by the terms of the appended claims.

List of Reference Signs:

1 flyback converter; 2 energy storage unit; 3 buck converter; 4 transformer; 5, 13 inductor; 6 first switch; 7 second switch; 8 bleeder resistance; 9 capacitor; 10 diode; 11 rectifying diode; 12 switch tube.

What is claimed is:

1. A power adapter comprising a first DC-DC converter and a device charging circuit, wherein
the first DC-DC converter has an input terminal and an output terminal,
the output terminal of the first DC-DC converter is connected to a first external port,
the device charging circuit comprises an energy storage unit and at least one second DC-DC converter, an output terminal of each of the at least one second DC-DC converter is connected to at least one second external port, the energy storage unit is connected to the output terminal of the first DC-DC converter and to the at least one second DC-DC converter so as to achieve at least one of the following:
receiving power outputted from the first DC-DC converter;
outputting power to the first external port; and
outputting power to the at least one second external port through the at least one second DC-DC converter.

2. The power adapter according to claim 1, wherein the power adapter further comprises a rectifier circuit, the rectifier circuit has an input terminal and an output terminal, the input terminal of the rectifier circuit is connected to an AC power while the output terminal of the rectifier circuit is connected to the input terminal of the first DC-DC converter.

3. The power adapter according to claim 2, wherein the first external port outputs a first voltage to a notebook computer for charging, and the first voltage comes from the AC power or the energy storage unit.

4. The power adapter according to claim 1, wherein the at least one second external port outputs a second voltage to mobile electronic devices for charging, and the second voltage comes from the AC power or the energy storage unit.

5. The power adapter according to claim 4, wherein the mobile electronic devices are a mobile phone, a digital camera, MP3, MP4, MP5, PMP, DSC, DVR, or a game machine.

6. The power adapter according to claim 1, wherein the energy storage unit is connected to both the input terminal and the output terminal of the first DC-DC converter, the energy storage unit outputs energy to the input terminal of the first DC-DC converter and outputs energy to the first external port through the first DC-DC converter, or receives energy outputted from the first DC-DC converter.

7. The power adapter according to claim 1, wherein the device charging circuit further comprises a third DC-DC converter, which is connected between the output terminal of the first DC-DC converter and the first external port.

8. The power adapter according to claim 7, wherein a notebook computer is connected to the first external port, and a power of the notebook computer provides energy to charge the energy storage unit through the third DC-DC converter.

9. The power adapter according to claim 7, wherein a notebook computer is connected to the first external port, and the third DC-DC converter provides energy which comes from the AC power or the energy storage unit to the notebook computer for charging.

10. The power adapter according to claim 7, wherein the third DC-DC converter comprises a buck converter.

11. The power adapter according to claim 1, wherein the first DC-DC converter comprises a flyback converter, a LLC converter, a full bridge converter, or a buck-boost converter; and
the second DC-DC converter comprises a buck converter.

12. The power adapter according to claim 1, wherein the at least one second external port is a USB port.

13. The power adapter according to claim 1, wherein the energy storage unit is a rechargeable element, or the energy storage unit comprises a power management circuit and a charging/discharging circuit.

14. The power adapter according to claim 2, wherein the rectifier circuit is a PFC circuit.

15. The power adapter according to claim 1, wherein the device charging circuit comprises a protection circuit which comprises an over power protection circuit and a short-circuit protection circuit.

16. The power adapter according to claim 2, wherein the power adapter further comprises a control circuit, which is connected with the rectifier circuit, the first DC-DC converter and the at least one second DC-DC converter for controlling operations thereof.

17. The power adapter according to claim 16, wherein the control circuit further comprises:
an input detecting circuit which is connected with the input terminal of the rectifier circuit for detecting whether the AC power is available or not;
a first load detecting circuit which is connected with the first external port for detecting whether a notebook computer is connected to the first external port or not; and
at least one second load detecting circuit which is connected with the at least one second external port for detecting whether at least one mobile electronic device is connected to the at least one second external port or not.

18. A controlling method of a power adapter which is recited in claim 2, wherein the method comprises the following steps:
detecting whether the AC power is available or not through the input terminal of the rectifier circuit;
detecting whether a notebook computer is connected to the first external port or not through the first external port;
detecting whether at least one mobile electronic device is connected to the at least one second external port or not through the at least one second external port; and
when the AC power is available, controlling the power adapter to operate in a first operating mode; when the AC power is unavailable, controlling the power adapter to operate in a second operating mode.

19. The controlling method of the power adapter according to claim 18, wherein the first operating mode is that:
the AC power provides energy to charge the energy storage unit through the rectifier circuit and the first DC-DC converter;
when the notebook computer is connected to the first external port, the first external port outputs voltage to charge the notebook computer, and the output voltage comes from the AC power; and
when at least one second load is connected to the at least one second external port, the at least one second external port outputs voltage to charge the at least one second load, and the output voltage comes from the AC power;
wherein the second operating mode is that:
when the notebook computer is connected to the first external port, the first external port outputs voltage to charge the notebook computer, and the output voltage comes from the energy storage unit; or the energy of the notebook computer power charges the energy storage unit through the first external port; and
when at least one second load is connected to the at least one second external port, the at least one second external port outputs voltage to charge the at least one second load, and the output voltage comes from the energy storage unit or the notebook computer power.

20. A notebook computer, which comprises the power adapter as recited in claim 1.
